(19) United States
(12) Patent Application Publication
(10) Pub. No.: US 2021/0295575 A1
(43) Pub. Date: Sep. 23, 2021

(54) INFORMATION PROCESSING METHOD, INFORMATION PROCESSING APPARATUS, MANUFACTURING SYSTEM, ARTICLE MANUFACTURING METHOD AND INTERFACE UNIT

(71) Applicant: CANON KABUSHIKI KAISHA, Tokyo (JP)

(72) Inventors: Yoshiaki Hiraoka, Kanagawa (JP); Shinji Murakami, Tokyo (JP); Kota Sakuma, Kanagawa (JP)

(21) Appl. No.: 17/197,157

(22) Filed: Mar. 10, 2021

(30) Foreign Application Priority Data
Mar. 19, 2020 (JP) 2020-049593

(51) Int. Cl. G06T 11/20; G06F 3/0484; G05B 19/418

(52) U.S. Cl. CPC G06T 11/206; H04L 67/12; G05B 19/41865; G06F 3/04847

(57) ABSTRACT

An information processing method includes acquiring contents of operations of devices and definition information defining temporal subordination of the operations in response to an input from a user, and generating a time chart of the operations based on the contents and the definition information.

### BACKGROUND OF THE INVENTION

### Field of the Invention

The present invention relates to an information processing apparatus.

### Description of the Related Art

Hitherto, a sequence program is utilized to control devices disposed in a production line or the like. As such sequence program, there is known a ladder program for example, and such sequence program is executed by a controller called as a PLC and a sequencer. In developing or debagging the sequence program of this sort, a time chart is prepared to verify an operating timing and a cycle time of an operation of a scheduled device.

The time chart of this sort assumes a mode of indicating each operation of the device by graphically aligning on a time base and indicates graphics indicating each operation by connecting by a line or an arrow in a case where there is context or dependency in terms of operation starting timing among the respective operations. Note that the dependency by which an operation timing of one device is determined while depending on an operation timing of another device among the plurality of devices will be referred to as subordination hereinafter.

In a case where there is such subordination among a plurality of operations, a time chart is prepared while adjusting positions of graphics by taking the operations of the plurality of devices into consideration. Therefore, a work thereof becomes cumbersome. Then, a method for readily preparing and editing such time chart is being proposed. For instance, Japanese Patent Application Laid-open No. 2004-227051 disposes graphics indicating operations on a time base and then when a user connects the graphics with each other by an arrow, disposes a graphic on an end point side such that an operation starting timing of the graphic on the end point side coincides with an operation completing timing of a graphic on a starting point side.

A work such as implementation of a sequence program is sometimes executed while making reference to a time chart. In such a case, it is desirable to be able to readily prepare and edit such time chart while considering and changing operational specifications of the devices to be able to swiftly advance such works.

An application such as a time chart editor is sometimes used on a screen through a GUI in preparing and editing the time chart. In a case of editing the time chart manually by such application and when a preceding operation among operations having subordination is edited, it is still necessary to manually edit a starting timing or the like of its succeeding operation.

Japanese Patent Application Laid-open No. 2004-227051 is arranged to automatically adjust positions of graphics when arrows indicating subordination are connected with each other. However, Japanese Patent Application Laid-open No. 2004-227051 does not consider to edit the positions of the graphics having the subordination and once disposed. Therefore, in a case of editing graphics other than those having the subordination indicated by the arrows, e.g., in a case of moving or expanding/contracting a main graphic having a subordinate graphic on a time base, it is necessary to manually perform an adjustment work such as the move of the subordinated graphic.

As for the time chart, it is desirable to be able to reduce a burden of the user by automatically performing a part of works of preparing and editing the time chart for example in terms of not only the subordination of graphics but also of changes of all operation specifications.

### SUMMARY OF THE INVENTION

A first aspect of the present invention is an information processing method including acquiring contents of operations of devices and definition information defining temporal subordination of the operations in response to an input from a user, and generating a time chart of the operations based on the contents and the definition information.

A second aspect of the present invention is an information processing apparatus including an acquisition portion configured to acquire contents of operations of devices and definition information defining temporal subordination of the operations in response to inputs from a user, and a generating portion configured to generate a time chart of the operations based on the contents and the definition information.

A third aspect of the present invention is an interface unit configured to set definition information for generating a time chart concerning operations of devices, wherein contents of the operations of the devices and temporal subordination of the operations as the definition information are set in response to an input from a user through the interface unit.

Further features of the present invention will become apparent from the following description of exemplary embodiments with reference to the attached drawings.

### BRIEF DESCRIPTION OF THE DRAWINGS

FIG. 1 is a block diagram illustrating a configuration of a time chart generating apparatus according to an exemplary embodiment of the present disclosure.

FIG. 2 illustrates a sequence chart sample according to the present exemplary embodiment of the present disclosure.

FIG. 3 illustrates time chart sample according to the present exemplary embodiment of the present disclosure.

FIG. 4 is a flowchart illustrating an exemplary process of an operation information acquisition processor according to the present exemplary embodiment of the present disclosure.

FIG. 5 is a flowchart illustrating an example of an operation starting time acquisition processor according to the present exemplary embodiment of the present disclosure.

FIG. 6 is a flowchart illustrating an exemplary process of an operation step information aligning processor according to the present exemplary embodiment of the present disclosure.

FIG. 7 is a flowchart illustrating an example of a time chart information generating processor according to the present exemplary embodiment of the present disclosure.

FIG. 8 is a diagram illustrating a time chart according to the present exemplary embodiment of the present disclosure.

FIG. 9 is a diagram illustrating a sequence chart according to the present exemplary embodiment of the present disclosure.

FIG. 10 is a table indicating operation step information according to the present exemplary embodiment of the present disclosure.

FIG. 11 is a table indicating subordination information according to the present exemplary embodiment of the present disclosure.

FIG. 12 illustrates tables indicating selection results of related operations according to the present exemplary embodiment of the present disclosure.

FIG. 13A is a table indicating a pattern 1 of another related operation according to the present exemplary embodiment of the present disclosure.

FIG. 13B is a table indicating a pattern 2 of a still other related operation according to the present exemplary embodiment of the present disclosure.

FIG. 14 is a table indicating operation step information into which the operation starting time is added according to the present exemplary embodiment of the present disclosure.

FIG. 15 is a table indicating operation step information into which transition source information is stored according to the present exemplary embodiment of the present disclosure.

FIG. 16 a diagram indicating a time chart after edition according to the present exemplary embodiment of the present disclosure.

FIG. 17 is a diagram illustrating one example of a work flow in a processing system of a sequence program (ladder program).

### DESCRIPTION OF THE EMBODIMENTS

A mode for carrying out the present disclosure will be described with reference to the appended drawings. Note that a configuration described below is a one example to the end, and a detailed configuration for example may be appropriately modified by a person skilled in the art within a scope not departing from a gist of the present disclosure. Still further, numerical values taken up in the present exemplary embodiment are merely examples of referential numerical values.

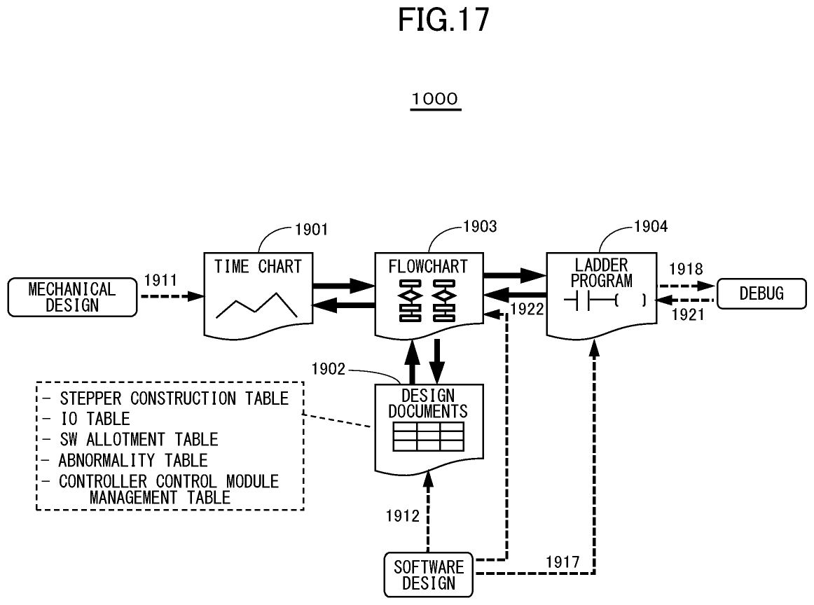

A configuration and operations of an information processing apparatus or of a time chart generating apparatus 100 in particular configured to generate and output a time chart describing operations of a device will be illustrated in the present exemplary embodiment. Note that the operations of the device described by the time chart are assumed to be controlled by a sequence program, e.g., a ladder program. This time chart is utilized to develop and verify a sequence program, e.g., a ladder program, in a development processing system as illustrated in FIG. 17 described below for example.

According to an information processing method of the present exemplary embodiment, a time chart which has been manually inputted or edited by a dedicated editor in the past is automatically generated and outputted based on definition information which is prepared by a user and which defines temporal context and subordination of operations of the device. In such a case, a time chart indicating the operations of a plurality of mutually related devices is generated based on the temporal context and the subordination defined in the definition information, and a graphic representation of the time chart is outputted or is displayed for example.

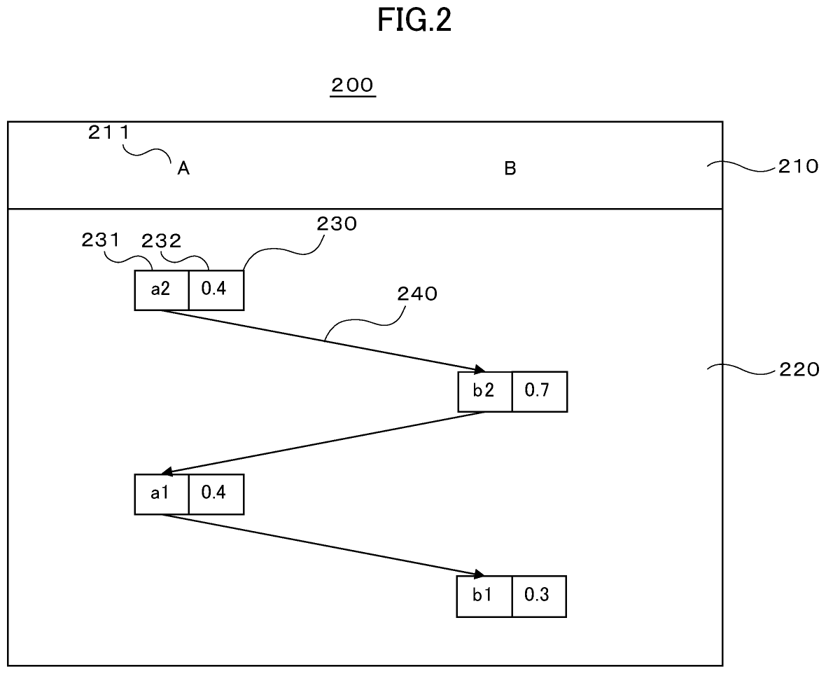

The user can prepare and edit the definition information of the present exemplary embodiment in a format of the sequence chart as illustrated in FIG. 2 described later for example on a GUI (graphic user interface) for example. The temporal context and the subordination of the operations of the devices are defined on the sequence chart, i.e., on the definition information. Therefore, even in a case of correcting a part of the operations of the plurality of related devices, it is possible to automatically output a time chart in which the temporal context and the subordinate are correctly adjusted in the graphical representation by editing related parts of the sequence chart, i.e., the definition information. It is possible to execute the output of the time chart through predetermined operations performed by the user through a user interface.

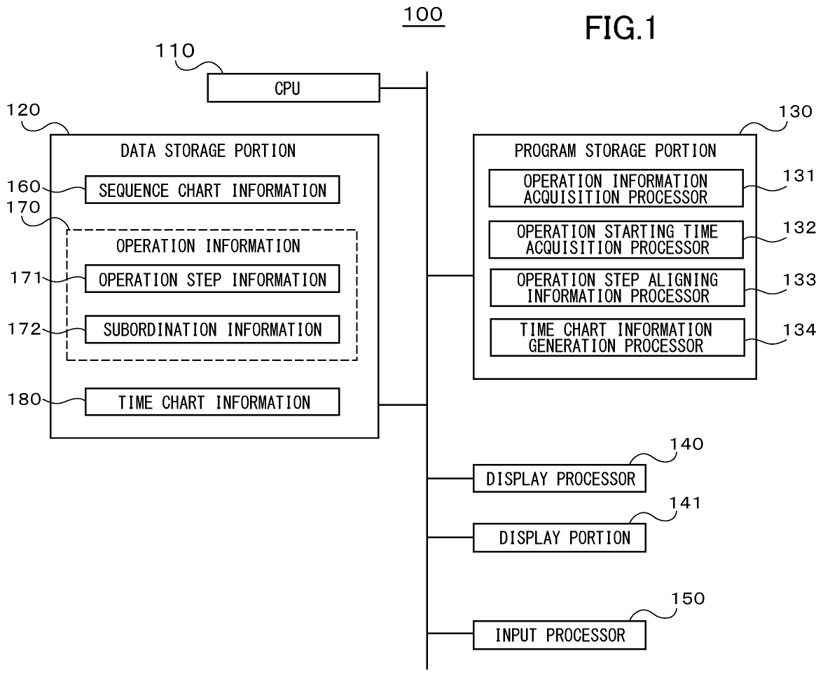

FIG. 1 is a block diagram illustrating a configuration of the time chart generating apparatus 100 according to the present exemplary embodiment. The time chart generating apparatus 100 includes a CPU 110, a data storage portion 120, a program storing portion 130, a display processor 140, a display portion 141 and an input processor 150.

The CPU 110 is a computer that performs various processes including arithmetic processing, a data preparing process, writing and reading processes into/out of memories in accordance to given instructions.

The data storage portion 120 is provided with storage areas for storing sequence chart information 160, operation information 170 and time chart information 180.

Programs that cause the CPU 110 to execute the respective processes are stored in an operation information acquisition processor 131 of the program storage portion 130, an operation starting time acquisition processor 132, an operation step information aligning processor 133 and a time chart information generation processor 134, i.e., a generating portion or a generating step. Storage media such as an EEPROM and a hard disk are used for the storage unit composing the program storage portion 130. It is also possible to use a drive of computer-readable storage media such as a removable optical disk and various memory devices for the program storage portion 130. It is possible to install, and to update, a control program describing control procedure of the present exemplary embodiment described later in the time chart generating apparatus 100 by using such computer-readable storage media. In such a case, the computer-readable storage media compose a storage medium of the present disclosure.

The display processor 140 performs a process for displaying information on a display portion 141 such as an LCD display composing the user interface. The input processor 150 performs a process of receiving information from an input unit such as a keyboard and a mouse composing the user interface. The user interface composed of the CPU 110, the display portion 141, the display processor 140, the input processor 150 and others composes a preparation unit executing a preparation step for preparing a sequence chart described later. Next, sequence chart information 160, operation information 170 and the time chart information 180 stored in the data storage portion 120 will be described in detail.

FIG. 2 illustrates a sample 200 of the sequence chart of the sequence chart information 160 for reference.

The sample 200 of the sequence chart in FIG. 2 is composed of an operation name setting portion 210 and a sequence setting portion 220. The sequence setting portion 220 includes information on an operation name 211. The operation name 211 includes title information of operations of the respective devices composing the unit. The sequence setting portion 220 includes information on operation step graphics 230 and connector graphics 240. The operation step graphic 230 indicates an operation of a unit to be controlled and includes information on transition destination name 231 and an operation time 232. The transition destination name 231 includes information indicating a state of each device composing the unit after when the device has been operated. The operation time 232 includes information on time required by each device composing the unit from a start to an end of the operation. The connector graphic 240 includes information on the subordinate between the respective operations.

Returning to FIG. 1, the operation information 170 includes operation step information 171 and subordinate information 172. The operation step information 171 includes operation name information, information on names of a move source and a move destination related to transition of operation status and operation time information.

The subordination information 172 includes operation step information on a starting point side and operation step information on an ending point side.

For instance, subordination information corresponding to the connector graphic 240 in FIG. 2 includes operation step information indicating that a transition destination of an operation name A is a2 and operation step information indicating that a transition destination of an operation name B is b2. The time chart information 180 will now be described in detail below.

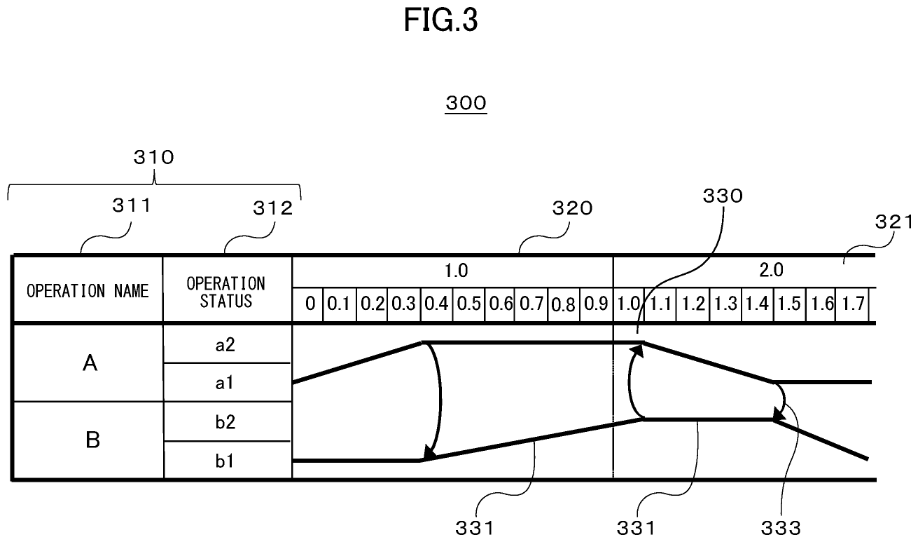

FIG. 3 illustrates a sample 300 of the time chart of the time chart information 180. The sample 300 of the time chart in FIG. 3 is composed of a setting portion 310, a time indicating portion 320 and a graphic drawing portion 330. The setting portion 310 includes information on an operation name 311 and an operation status 312. The operation name 311 includes name information of the operations of the respective devices composing the unit. The operation status 312 includes information indicating statuses before and after the operations of the respective devices composing the unit. The time indicating portion 320 includes time information 321. The graphic drawing portion 330 includes information on oblique lines 331 indicating that the device is in operation, a horizontal line 332 indicating that the device is in a stand-by state and circular-arc arrows 333 indicating the subordinates among different operations.

FIG. 17 is a schematic diagram illustrating a workflow of development and design works of a sequence program, i.e., a ladder program, as one example of an environment in which the time chart as described above is utilized. A mechanical designer performing various design works related to hardware of a production unit prepares a time chart 1901 by a time chart preparing work 1911. Technologies for generating and displaying the time chart 1901 by utilizing the sequence chart will be described in the present exemplary embodiment.

Operating sequences and dependency of the respective production devices in a production step are described in the time chart 1901. Receiving the completed time chart 1901, a software designer starts design works. Here, the software designer performs a design document preparing work 1912 to prepare a design documents 1902 composed of a stepper structure table, an 10 table, a SW allotment table, an abnormality table, a controller control module management table and others.

Still further, the software designer prepares or automatically generates a flowchart 1903 based on the design documents 1902 composed of the stepper structure table, the 10 table, the SW allotment table, the abnormality table, the controller control module management table and others and on the time chart 1901. Note that in a case of automatically generate the flowchart 1903 from the time chart 1901, there is a case where such a process of automatically describing design information from the design documents 1902 into the flowchart 1903 is performed in a manner of difference addition.

Then, the software designer confirms the prepared flowchart 1903 and corrects the flowchart 1903 corresponding to branch conditions, standby conditions, processing contents after being branched by the branch conditions and the like.

Next, the software designer describes and edits the ladder program 1904, i.e., the sequence chart, by a dedicated editor or the like by making reference to the design documents 1902. Alternately, there is also a case of automatically generating the ladder program 1904 in response to the flowchart 1903 and the design documents 1902. Note that there is also a case of slightly correcting the flowchart 1903 and the design documents 1902 on which the ladder program 1904 is based as indicated by arrows in a left direction in FIG. 17 in response to debugging, preparation and edition of the ladder program 1904, i.e., the sequence chart. Finally, the software designer performs confirm works 1917 of the ladder program 1904 and ends the design flow.

The ladder program 1904, i.e., the sequence chart, thus prepared is transferred to an integrated control unit such as a sequencer (PLC) that controls a group of devices disposed in a production line for example. This integrated control unit controls the plurality of production devices disposed in the production line, e.g., a manufacturing system of an article, and can manufacture industrial products or their parts by conveying, processing or assembling workpieces by those production devices. In such a case, it is also possible to arrange such that the sequence program, i.e., the ladder program, is automatically generated from the time chart and the flowchart generated by the processes of the present exemplary embodiment and such that the integrated control unit controls the production devices by the sequence program, i.e., the ladder program.

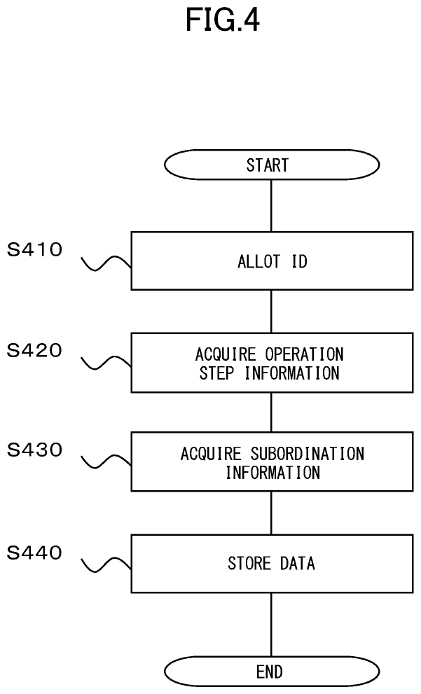

Each portion included in the program storage portion 130 in FIG. 1 will be described below in detail. FIG. 4 is a flowchart illustrating an exemplary process of the operation information acquiring processor 131.

Firstly, the CPU 110 allots IDs to the respective operations contained in the sequence chart information 160 stored in the data storage portion 120 in step S410.

In step S420, the CPU 110 acquires the operation step information 171 by extracting an operation name, a transition destination name and an operation time in unit of ID from the sequence chart information 160.

In step S430, the CPU 110 acquires the subordination information 172 by extracting subordination among the operations from the sequence chart information 160.

In step S440, the CPU 110 stores the operation step information 171 and the subordination information 172 thus acquired into the data storage portion 120.

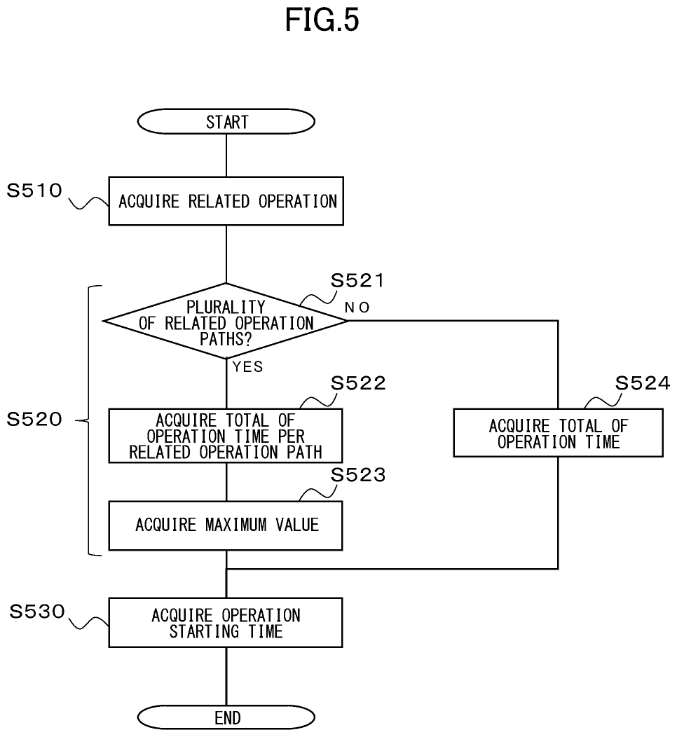

FIG. 5 is a flowchart illustrating an exemplary process of the operation starting time acquisition processor 132. In step S510, the CPU 110 acquires the subordination information 172 contained in the sequence chart information 160 stored in the data storage portion 120. Then, the CPU 110 selects IDs of subordinated related operations linked directly or in cascade among antecedently executed operations as for the respective operations.

In step S520, the CPU 110 acquires a total of the operation times of the operations contained in the selected related operations, i.e., in steps S521 through S524. In a case where there is a plurality of related operation passes, i.e., Yes in step S521, the CPU 110 acquires a related operation pass in which a total value of the operation time of the operation contained in the related operation pass is largest in step S523. In a case where there is no plurality of related operation passes, i.e., No in step S521, the CPU 110 acquires a total value of the operation time in step S524.

In step S530, the CPU 110 stores the value obtained in step S520 to the operation starting time of each operation step information 171.

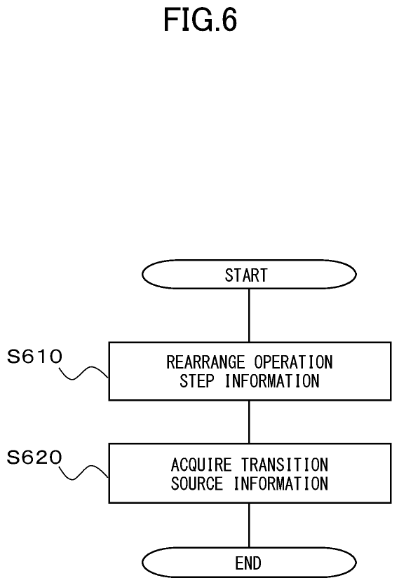

FIG. 6 is a flowchart illustrating an exemplary process of the operation step information aligning processor 133. In step S610, the CPU 110 rearranges the operation step information 171 per each operation name and rearranges further in order of smaller operation starting time under the same operation names.

In step S620, the CPU 110 acquires the transition source name of the immediately preceding operation step information 171 having the same operation name for each of the operation step information 171 and adds as the transition source name. Note that as for the transition source name of the top operation step information 171 of the respective operation names, the CPU 110 adds a transition destination name held by the last operation step information 171 of the respective operation names for example.

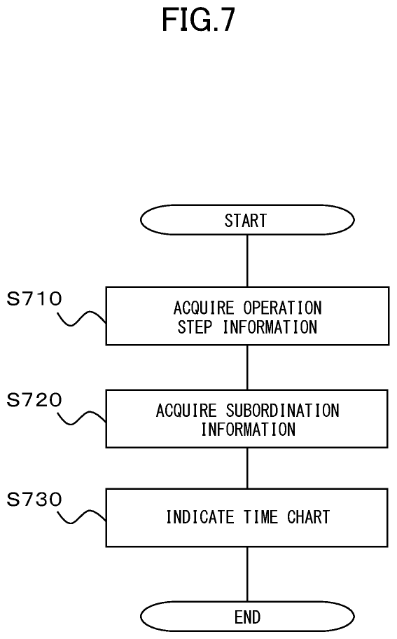

FIG. 7 is a flowchart illustrating an example of a control procedure of the time chart information processor 134. In step S710 in FIG. 7, the CPU 110 acquires the respective operation step information 171 stored in the data storage portion 120.

In step S720, the CPU 110 acquires the respective subordinate information 172 stored in the data storage portion 120.

In step S730, the CPU 110 generates the time chart information 180 from the respective operation step information 171 and the respective subordinate information 172 thus acquired and generates and displays display information so that the user can readily observe.

A procedure for generating and editing a time chart by exemplifying a machining robot as an object to be controlled.

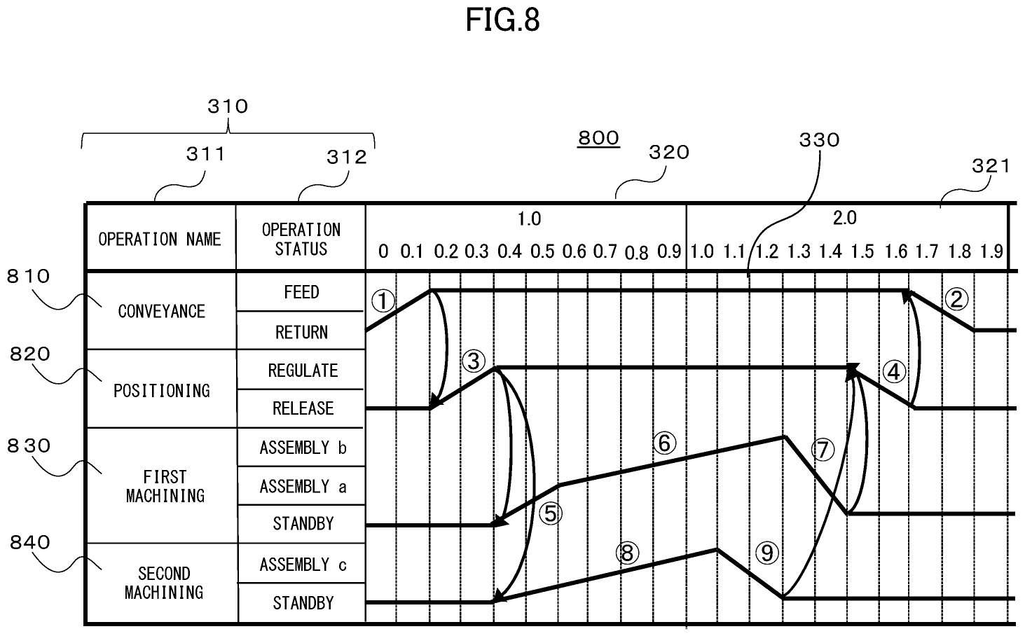

FIG. 8 is a diagram illustrating a time chart of an object to be processed according to the present exemplary embodiment. The time chart 800 is what is prepared by the CPU 110 based on the time chart information 180 stored in the data storage portion 120 for example. In FIG. 8, the respective elements are indicated by using the same reference signs with those indicated in FIG. 3 and their functions are the same as described in FIG. 3.

The time chart 800 in FIG. 8 includes, in the setting portion 310, the operation name 311 indicating a type of an operation of the machining robot and the operation status 312 indicating the operation status that can be taken by the machining robot before and after each continuous operation. The time indicating portion 320 is arranged to have time information 321 composed of time base grids per 0.1 second and the graphic drawing portion 330 includes a graphic column in which transitions of the operation statuses are indicated graphically.

Four types of operations are indicated in the operation name 311 of FIG. 8, i.e., a conveyance operation 810, a positioning operation 820, a first machining operation 830 and a second machining operation.

The operation status 312 in FIG. 8 indicates operation statuses, i.e., operation steps, that can be taken by the machining robot before and after each operation. That is, a returning position and a feeding position are indicated as for the conveyance operation 810, a releasing position and a regulating position are indicated as for the positioning operation 820, standby, assembly a and assembly b are indicated as for the first machining operation 830 and standby and assembly c are indicated as for the second machining operation 840.

The graphic drawing portion 330 in FIG. 8 indicates a state in which the status transits along an elapse of time in each operation by a line graph and indicates parts of oblique lines during periods in which statuses transmit are indicated by IDs of circled numbers. Note that the circled numbers in FIG. 8 are referred by numbers with parentheses in the following text due to restriction of character code.

For instance, as for the conveyance operation 810, while a conveyance mechanism of the machining robot can take two states of the returning position and the feeding position, the machining robot moves from the returning position to the feeding position during 0.2 second from 0 second of the time base. For instance, the line graph drawn right upward during the period of the circled number (1) for example indicates a move to the feeding position, and an operation time required from a start to an end of the operation of this time is 0.2 seconds. This circled number (1) indicates the ID allotted to the operation step information which is a base of the moving operation from the returning position to the feeding position. Still further, the line graph of the conveyance operation from 0.2 seconds to 1.7 seconds is horizontal, indicating that the conveyance mechanism is stopping at the feeding position. Then, an operation to which ID of a circled number (2) is allotted, i.e., a move from the feeding position to the returning position, is performed during a period from 1.7 seconds to 1.9 seconds. That is, a move from the feeding position to the returning position is made. The line graph drawn right downward during this period indicates that it is a move to the returning position. The line graph is horizontal on and after 1.9 seconds, indicating that the conveyance mechanism is stopping at the returning position.

Still further, a circular-arc arrow extends into the positioning operation from an ending point of time of the operation of the circled number (1), and an operation of a circled number (3) of transiting from the releasing state to the regulating state in the positioning operation is started. This indicates the subordination that the operation of the circled number (2) is started following a completion of the operation of the circled number (1).

Still further, a circled number extends from the ending point of time of an operation of a circled number (7) of the first machining operation and an ending point of time of an operation of a circled number (9) of the second machining operation, and an operation of a circled number (3) is started. This indicates that an operation of a circled number (4) is started following to, i.e., depending on, the completion of the operations of the circled number (7) and the circled number (9).

Thus, the time chart 800 of the present exemplary embodiment indicates a series of operation sequence of that the machining robot conveys a workpiece, positions on a workbench, releases positioning after performing two types of machining and coveys the workpiece to the returning position.

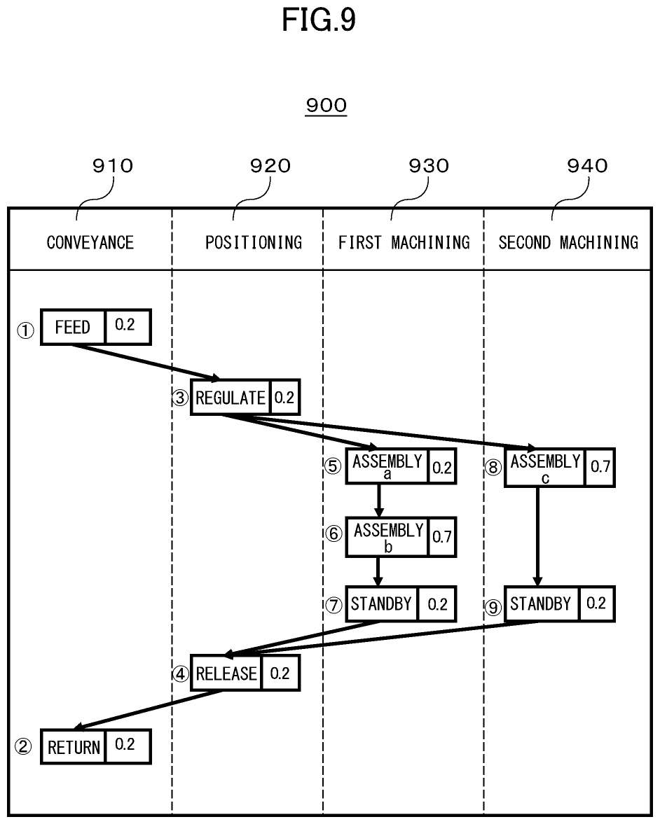

Next, the sequence chart which becomes input data for generating the time chart 800 in FIG. 8 will be described with reference to FIG. 9.

The sequence chart 900 in FIG. 9 is what indicates the sequence chart information 160 stored in the data storage portion 120 and is what prepared by the user. The sequence chart 900 includes, at an upper part thereof, an operation name setting column indicating types of operations of the machining robot and, at a lower side thereof, a sequence setting column indicating quadrangles indicating each operation step in each operation and arrows indicating subordination among the respective operations. Note that the quadrangles in these drawings will be referred to as “operation step graphics” hereinafter.

The user can input and/or edit the sequence chart 900 having such graphic display through the graphic user interface (GUI) composed of the input processor 150, the display processor 140, the display portion 141 and others.

The four types of operations corresponding to the operations 810 to the 840 in FIG. 8 in the operation name column in FIG. 8, i.e., the conveyance operation 910, the positioning operation 920, the first machining operation 930 and the second machining operation 940, are indicated in the operation name column in FIG. 9.

The sequence setting column in FIG. 9 indicates the operations indicated by quadrangles including names on a left side thereof each indicating a status after the operation and a value indicating an operation time per operation name, i.e., 910,920,930 and 940.

For example, as for the conveyance operation 910, operations of moving to the feeding position in 0.2 seconds and of moving to the returning position in 0.2 seconds are indicated. Note that the circled number (1) indicates ID allotted to the moving operation to the feeding position.

Still further, an arrow extends from the operation step graphic of the circled number (1) of the conveyance operation into the positioning operation and is connected to an operation of a circled number (3) of transiting to the regulated state. This indicates that the operation of the circled number (3) is started following the completion of the operation of the circled number (1).

Still further, arrows extend from an operation step graphic of a circled number (7) of the first machining operation and an operation step graphic of a circled number (9) of the second machining operation and are connected to an operation step graphic of a circled number (4). This indicates that an operation of the circled number (4) is started following completion of the both operations of the circled number (7) and the circled number (9).

As described above, the sequence chart 900 of the present exemplary embodiment indicates the same series of operation sequence with that of the time chart 800.

Next, one example of the time chart generating operation will be described with reference to FIGS. 8 and 9.

As an instruction of starting to generate the time chart is inputted into an input portion, the CPU 110 firstly performs a process of acquiring and storing various information in accordance to the flowchart in FIG. 4.

In step S410 at first, the CPU 110 acquires the sequence chart that has been prepared by the user in the sequence chart preparing step as the user instructs to generate the sequence chart through the user interface. Then, the CPU 110 allots the IDs indicated by the circled numbers described above to the respective operation step graphics described in the sequence chart 900 thus obtained.

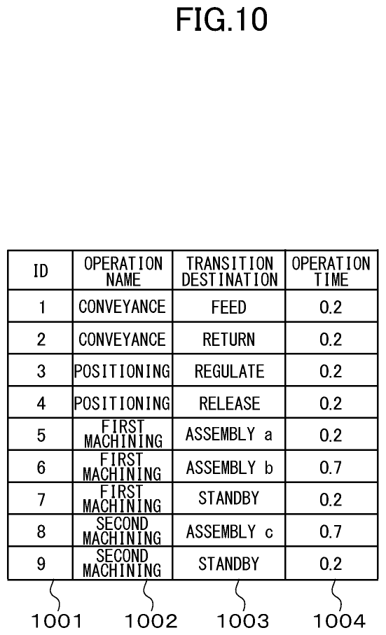

In step S420, the CPU 110 acquires the operation step information 171 from the sequence chart 900. The operation step information 171 includes the definition information describing aspects of the operations such as operation names and operation times per unit of IDs. FIG. 10 specifically illustrates one example of the operation step information 171 at a point of time of the step S420. In the example in FIG. 10, the operation step information includes an operation name 1002, a transition destination 1003) of transition of the operation status, an operation time 1004 per respective operation indicated by the ID 1001. Note that numerals indicated in the ID column on and after FIG. 10 correspond to the ID indicated by the circled numbers in FIG. 8 for example.

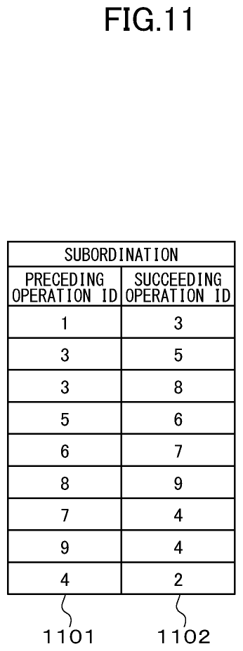

In step S430, the CPU 110 acquires the subordination information 172 including the definition information of the subordination among the respective operations from the sequence chart 900. FIG. 11 specifically illustrates one example of the subordination information 172. The subordination information 172 includes IDs 1101 and 1102 of the two operation step information 171 mutually subordinated.

In step S440, the CPU 110 stores the operation step information 171 and the subordination information 172 into the operation information 170 of the data storage portion 120.

Next, the CPU 110 acquires the operation starting times of the respective operation by the process of the flowchart in FIG. 5 and adds them into the operation step information.

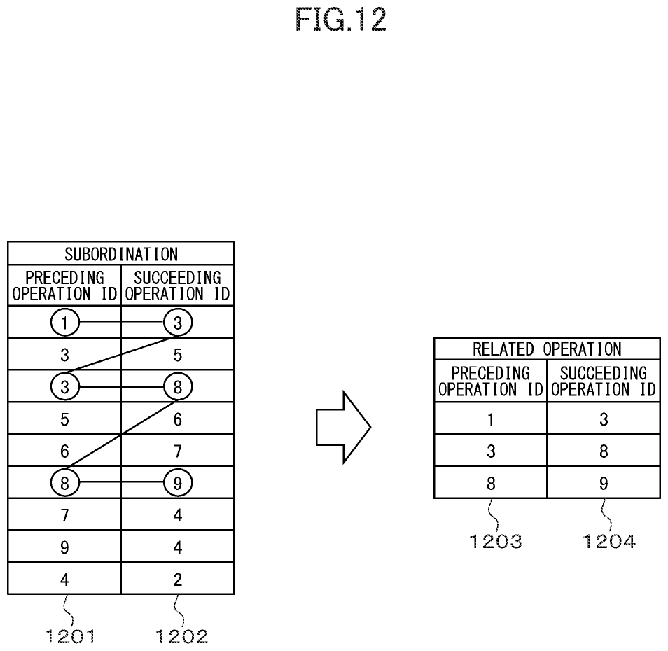

In step S510, the CPU 110 selects related operations of the respective operations included in the subordination information 172 of the operation information 170 included in the data storage portion 120 by the subordinate operation extracting step. Here, the related operation refers to an operation linked directly or in cascade among operations executed in advance of a target operation. Here, FIG. 12 illustrates a state of extracting and selecting related preceding operations ID 1203 and succeeding operation IDs 1204 as illustrated on a right-side table by retrieving the related operations from rows of preceding operation ID 1201 and succeeding operation ID 1202 on a left-side table. Here, the series of related operations related to the operation of ID 9 is extracted and selected as illustrated in a right-side table in FIG. 12.

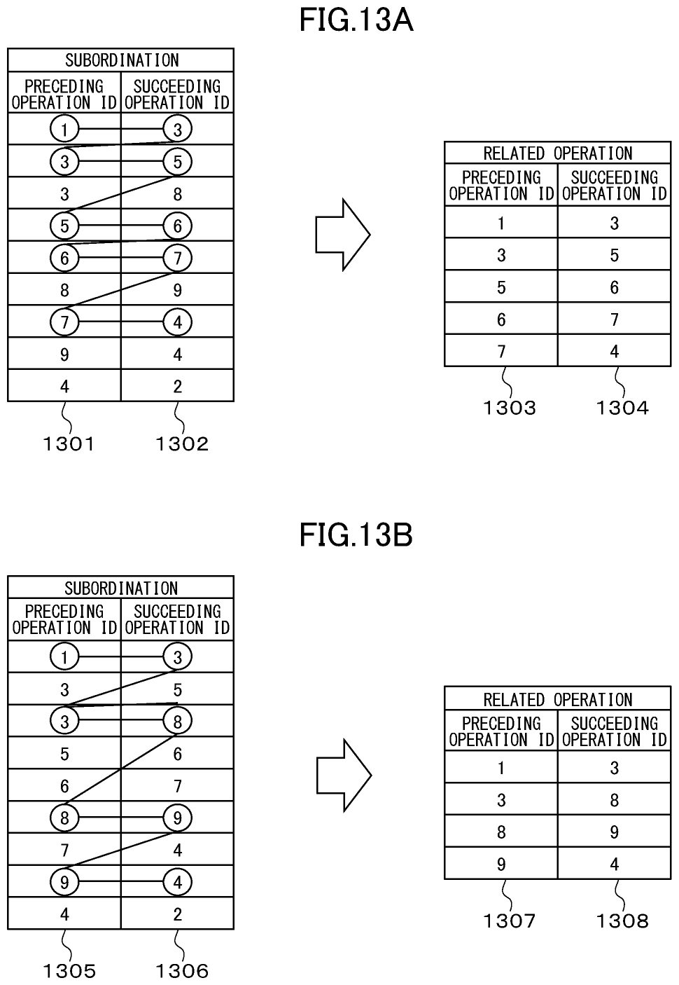

FIGS. 13A and 13B illustrate states in selecting other related operations. The states in FIGS. 13A and 13B are the same with those in FIG. 12. FIG. 13A illustrates rows of original preceding operation IDs 1301 and succeeding operation IDs 1302 in a left-side table and illustrates rows of preceding operation IDs 1303 and of succeeding operation IDs 1304 after the selection in a right-side table. FIG. 13B also illustrates rows of original preceding operation IDs 1305 and succeeding operation IDs 1306 in a left-side table and illustrates rows of preceding operation IDs 1307 and of succeeding operation IDs 1308 after the selection in a right-side table.

FIGS. 13A and 13B specifically illustrate the states of selecting the related operations as their results. In this example, there are two lines of paths of the preceding operations to which the ID 4 subordinates. That is, a first one of the path of the preceding operations to which the ID 4 subordinates is a pattern 1 of ID 7, ID 6, ID 5, ID 3 and ID 1 indicated in FIG. 13A. A second one of the preceding operations to which the ID 4 subordinates is a pattern 2 of ID 9, ID 8, ID 3 and ID 1 indicated in FIG. 13B.

In step S520, the CPU 110 acquires the total of the operation times of the operations contained in the selected related operations in step S522, step S523 or step S534. In a case where there is a plurality of related operations, i.e., Yes in step S521, the CPU 110 acquires an operation contained in the related operations for which a total value of the operation times is largest in step S523.

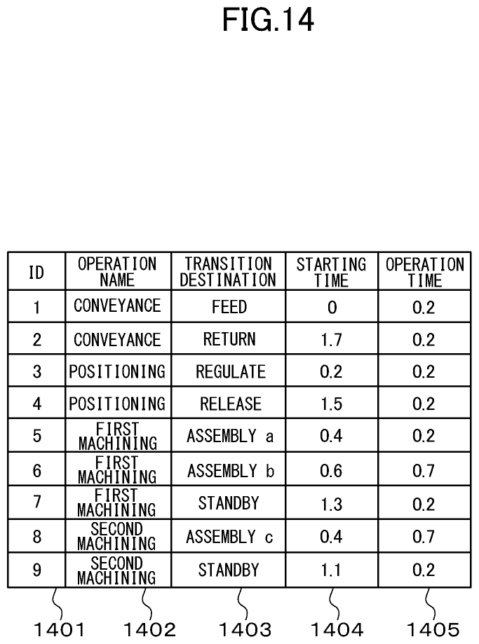

In step S530, the CPU 110 stores the value acquired in step S520 to the operation starting time of the respective operation step information 171. FIG. 14 is a table specifically indicating one example of the operation step information 171 into which operation name 1402, transition destination 1403 of a transition of an operation status, operation time 1404 and operation starting time 1404 are added per each operation indicated by the ID 1401. It is possible to decide a graphical shape of the time chart by using the starting and ending times thus acquired.

Next, the CPU 110 rearranges the operation step information 171 per operation name, aligns in step S610 and acquires information a in step S620. In step S610 in FIG. 6, the CPU 110 rearranges the respective operation step information 171 per operation name and rearranges further in order of smaller operation starting time under the same operation name.

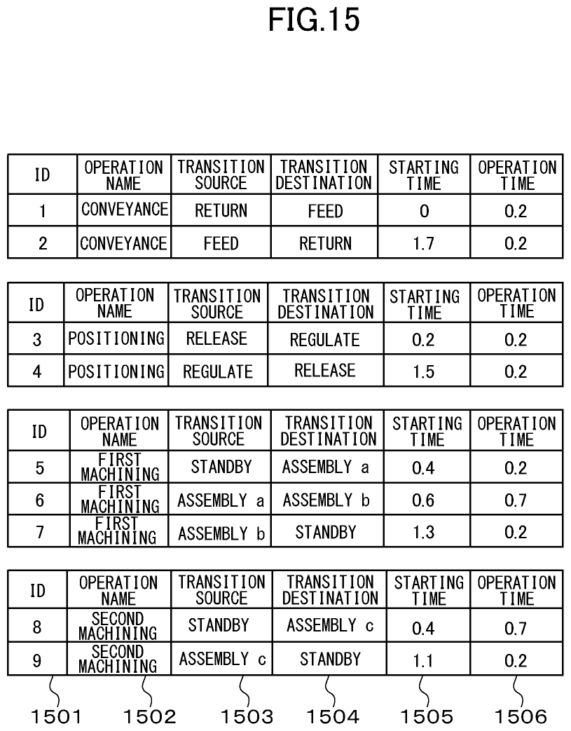

In step S620 in FIG. 6, the CPU 110 acquires a transition source name of the operation step information 171 immediately before for each operation step information 171 and stores into the transition source name. Still further, as for the transition source name of the top operation step information 171 of the respective operation names, the CPU 110 acquires and adds a transition destination name of the final operation step information 171 of the respective operation names. The operation step information in FIG. 15 includes operation names 1502, transition sources 1503 of the operation status, transition destinations 1504 of the operation status, starting times 1505 and operation times 1506 per each operation indicated by the ID 1001.

Next, the CPU 110 indicates the time chart through the processes in FIG. 7. Firstly, the CPU 110 acquires the operation step information 171 and the subordination information 172 from the data storage portion 120 in step S710 in FIG. 7.

Next, in step S720 in FIG. 7, the CPU 110 prepares and indicates generation information of the time chart 800 from the operation step information 171 and the subordination information 172. Here, the CPU 110 generates information for indicating an operation name column, an operation status column, and line graphs in the graph column in the time chart 800 from the operation name and the transition destination name in the operation step information 171. Still further, the CPU 110 generates information for indicating circular-arc arrows from the subordination information 172.

According to the present exemplary embodiment, it is possible to readily generate the time chart in FIG. 8 based on the sequence chart by preparing the sequence chart as illustrated in FIG. 9 for example through the processes as described above.

Because the sequence chart defines the transition and subordination of the operation statuses and if a change of operation specification of a device to be controlled is to be made, it is possible to generate the time chart corresponding to an operation after the change readily and automatically by editing the sequence chart for example. A process of correcting the time chart along the change of the operation specification of the unit to be controlled can be executed as follows for example.

For instance, an operation time of an operation of the ID 6 in the time chart 800 in FIG. 8 is to be changed from 0.7 seconds to 0.4 seconds. In a case of directly correcting the time chart, a right end of the oblique line indicating the operation of the ID 6 is contracted to a position of 1.0 second. Then, along with that, it becomes necessary to correct also succeeding subordinated operations.

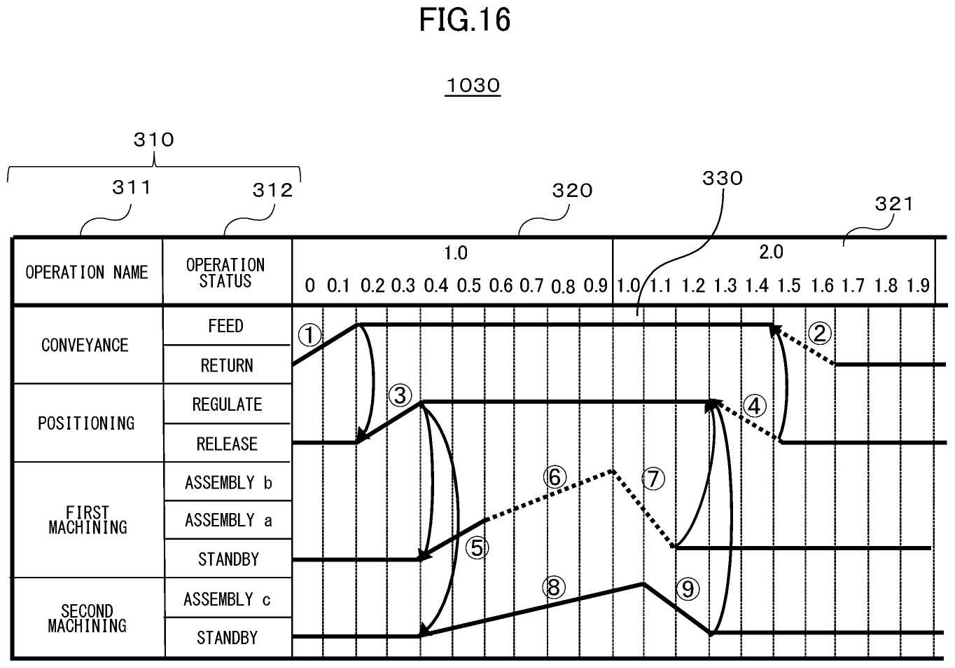

FIG. 16 is a diagram illustrating a time chart 1000 after the correction in a case of correcting the operation of the ID 6. A graphical format of FIG. 16 is the same with those of FIGS. 3 and 8 described above, and the same reference signs are used for the same or corresponding parts. In the corrected time chart 1000 in FIG. 16, the corrected operations are indicated by dotted lines. In this case, the operation time of the ID 6 is changed and a starting time of the ID 7 is advanced by 0.3 seconds. Then, because the operation starting time of the ID 4 depends on the related operations including the operation of the ID 9, starting time of the operation of the ID 4 and of the ID 2 subordinated thereto are also changed. Thus, when the operation time is partly changed, it becomes necessary to correct a plurality of operation starting times depending on that correction and works thereof become extremely cumbersome if such operation is to be carried out manually.

However, according to the present exemplary embodiment, it is possible to readily generate the corrected time chart 1000 as illustrated in FIG. 16 just by correcting the sequence chart 900. For instance, the operation time of the ID 6 of the sequence chart 900 is changed from 0.7 seconds to 0.4 seconds. Next, the user instructs to generate the time chart and displays the corrected time chart 1000 by executing the processes as illustrated in FIGS. 4 through 7. At this time, the work of the user is completed just by changing the operation time of the ID 6 of the sequence chart 900, and the corrected time chart 1000 as illustrated in FIG. 16 is automatically generated and is outputted.

That is, according to the present exemplary embodiment, the CPU executes the respective processes again just by changing the operation specification by the sequence chart, acquires information of all of the operations and can automatically regenerate the time chart corresponding to the status of the sequence chart. Because the works of the user are completed just by correcting only a part to be changed, it is not necessary to edit the time chart directly and manually and work efficiency for preparing and editing the time chart can be significantly improved.

The present exemplary embodiment of the present disclosure is not limited to the examples described above and may be appropriately modified, omitted or assembled. For instance, information such as the sequence chart and the time chart indicated in the display portion is not limited to the format described above. The display result may be not only displayed but also be printed to provide to the user. Still further, the unit to be controlled is not limited to be the machining robot, and the generating method of the present disclosure is broadly applicable as long as the unit is controlled by using a sequence program. The present disclosure can be used preferably for control of various devices provided with an electromagnetic valve and an air cylinder and for operation analysis of an assembly robot. Still further, the present disclosure is applicable to a machine that can automatically make a telescopic motion, a bending and stretching motion, a vertical motion, a horizontal motion or a swiveling motion or their complex motion based on information of a storage device provided in the control unit.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-049593, filed Mar. 19, 2020, which is hereby incorporated by reference herein in its entirety.

What is claimed is:

1. An information processing method comprising:
acquiring contents of operations of devices and definition information defining temporal subordination of the operations in response to an input from a user; and
generating a time chart of the operations based on the contents and the definition information.

2. The information processing method according to claim 1, further comprising graphically indicating the time chart.

3. The information processing method according to claim 2, wherein an input and/or editing operation from the user concerning a sequence chart including a plurality of graphics respectively indicating the contents and arrows indicating the subordination by connecting the graphics with each other is inputted as the input through a user interface.

4. The information processing method according to claim 3, wherein each of the contents includes information on steps of an operation and on times necessary for executing the steps.

5. The information processing method according to claim 4, wherein names of the operations are indicated in the sequence chart.

6. The information processing method according to claim 4, wherein each of the steps includes at least one of feed, return, regulation of position, release of position, assembly and standby.

7. The information processing method according to claim 5, wherein each of the operations includes at least one of conveyance, positioning and machining.

8. The information processing method according to claim 5, wherein the sequence chart includes areas set corresponding to the operations, and
wherein the steps corresponding to the operations are indicated by being separated per area.

9. The information processing method according to claim 5, wherein the names of the operations are indicated on upper parts of the graphics in the sequence chart.

10. The information processing method according to claim 3, wherein the time chart is graphically indicated through the user interface.

11. The information processing method according to claim 3, wherein the definition information is updated based on the sequence chart inputted and/or edited through the user interface, and
wherein the time chart is updated based on the updated definition information inputted and/or edited through the user interface.

12. The information processing method according to claim 4, wherein the steps and the times are indicated in the graphics so as to be able to input and/or edit through the user interface.

13. A computer-readable non-temporal storage medium configured to store a control program configured to execute the information processing method according to claim 1 by a computer.

14. An information processing apparatus comprising:
an acquisition portion configured to acquire contents of operations of devices and definition information defining temporal subordination of the operations in response to inputs from a user; and
a generating portion configured to generate a time chart of the operations based on the contents and the definition information.

15. The information processing apparatus according to claim 14, further comprising a display portion configured to graphically indicate the time chart.

16. The information processing apparatus according to claim 15, wherein the acquisition portion receives an input and/or editing operation from the user concerning a sequence chart including a plurality of graphics respectively indicating the contents and arrows indicating the subordination by connecting the graphics with each other as the input through a user interface.

17. The information processing apparatus according to claim 16, wherein each of the contents includes information on steps of an operation and times necessary for executing the steps.

18. The information processing apparatus according to claim 16, wherein the acquisition portion updates the definition information based on the sequence chart inputted and/or edited through the user interface, and
wherein the generating portion updates the time chart based on the updated definition information inputted and/or edited through the user interface.

19. The information processing apparatus according to claim 17, wherein the information processing apparatus indicates the steps and the times in the graphics so as to be able to input and/or edit through the user interface.

20. A manufacturing system comprising:
the information processing apparatus according to claim 14; and
the devices,
wherein the devices are configured to execute the operations described in the time chart generated by the information processing apparatus to manufacture an article.

21. An article manufacturing method configured to manufacture an article by using the manufacturing system according to claim 20.

22. An interface unit configured to set definition information for generating a time chart concerning operations of devices,
wherein contents of the operations of the devices and temporal subordination of the operations as the definition information are set in response to an input from a user through the interface unit.
